(19) United States
(12) Patent Application Publication
(10) Pub. No.: US 2016/0267167 A1
(43) Pub. Date: Sep. 15, 2016

(54) METHOD AND SYSTEM FOR PROFILING USERS OF A DATABASE AND PRESENTING PREDICTIVE INFORMATION

(71) Applicant: TBT HOLDINGS AUSTRALIA PTY LTD, Sydney, New South Wales (AU)

(72) Inventor: Shane Darren FINN, Sydney (AU)

(21) Appl. No.: 15/030,372

(22) PCT Filed: Oct. 17, 2014
(86) PCT No.: PCT/AU2014/050294

§ 371 Date: Apr. 18, 2016

(30) Foreign Application Priority Data
Oct. 17, 2013 (AU) 2013903993
Oct. 21, 2013 (AU) 2013904044

(51) Int. Cl. G06F 17/30

(52) U.S. Cl. CPC G06F 17/30598; G06F 17/30867; G06F 17/3087

(57) ABSTRACT

A method and a system for analysing in a prescribed domain interests of a persona who interacts with a repository of information containing: items that may embody one or more interests of a persona in that domain, categories that are a collection of all possible interests of a persona relative to that domain, and values that constitute a measure of the quality or quantity prescribed for each interest. A method and a system for analysing in a prescribed domain preferences of a persona who interacts with a repository containing: items that may embody one or more interests of a persona in that domain, relationships between the items, and attribute values that constitute a measure of the quality or quantity prescribed for each relationship. A method and a system for suggesting items in a prescribed domain that are aligned with the predetermined interests and preferences of a persona stored in a repository of information in response to an item plan access of a persona interacting with the repository, the repository including: items that may embody one or more interests of a persona in that domain, categories that are a collection of all possible interests of a persona relative to that domain, values that constitute a measure of the quality or quantity prescribed for each interest, relationships between the items, and attribute values that constitute a measure of the quality or quantity prescribed for each relationship.

### FIELD OF THE INVENTION

This invention relates to methods and systems for profiling a user of a database having regard to their interests and preferences in accessing data and information provided in the database, and presenting predictive information to the user based upon the user's interaction with the database.

The invention has utility in many fields including search engines, data mining and customised applications, in particular, although not exclusively, travel planning and meal planning. With respect to travel planning, it can be embodied in modes to learn of a user's interest and preferences for travel and make use of this information to suggest future locations in a planned trip that the traveller may find appealing. With respect to meal planning, it can be embodied in modes to learn of a user's interest and preferences for meals and ingredients and make use of this information to suggest future recipes and ingredients that the user may find appealing.

With regard to travel planning, the invention can also be embodied in modes that provide the visual presentation of travel plans that can provide a traveller's location, planned trips, suggested future locations, the location of members of a travelling community, their trip plans, and descriptions of and feedback on travel locations.

Definitions of particular terms used in this specification include:

a ‘persona’ is an individual or a group that shares a common behaviour or intent, for example:
(i) in a travel planning context a persona may be an individual travelling alone, an individual acting as a representative delegate for a group, the common behaviour of individuals acting independently, or the common behaviour of individuals acting together;
(ii) in a meal planning context a persona may be an individual consumer acting alone, a chef acting on behalf of a known or expected group or the aggregate observed or expected behaviour of a group:

a ‘trusted persona’ is an individual or group that another persona trusts the judgement or evaluation of;

an ‘interest’ is something that draws the attention of a persona, for example:
(i) in a travel planning context an interest may be golf, fishing, shopping, markets, museums, art, culture;
(ii) in a meal planning context an interest may be quick meals, elaborate meals, single course meals, multi-course meals, styles of cuisine such as Malaysian, Indian, French;

an ‘item’ is an embodiment of an interest to a persona, for example:
(i) in a travel planning context an item may be continents, countries, states, regions, cities, towns, business or charitable premises, places of nature, activities, events, a partial or complete itinerary along with the dates and times these items are accessible;
(ii) in a meal planning context an item may be completed meals, a course of a meal, a side dish of a meal, food ingredients, cooking appliances or equipment along with the dates and times these items are accessible;

a ‘set’ is a collection of ‘items’ that enables fulfilment of a persona intent, for example:
(i) in a travel planning context a set may be a list of locations, often in the order of arrival, that will be visited during travel;
(ii) in a meal planning context a set may be menus, ingredient lists, recipes;

a ‘preference’ is a guiding principle that aids a persona in deciding amongst alternatives, for example:
(i) in a travel planning context a preference may be longest distance or time to be travelled per day, the distance the persona is prepared to deviate from optimal path to visit interests, the desire to revisit old destinations, the desire to visit new destinations, to limit trips to within a certain duration or within certain dates;
(ii) in a meal planning context a preference may be use of particular cooking appliances or equipment, methods of cooking such as roasted, deep fried, boiled, stir fried.

In addition, throughout the specification, unless the context requires otherwise, the word “comprise” or variations such as “comprises” or “comprising”, will be understood to imply the inclusion of a stated integer or group of integers but not the exclusion of any other integer or group of integers.

### BACKGROUND ART

The following discussion of the background art is intended to facilitate an understanding of the present invention only. It should be appreciated that the discussion is not an acknowledgement or admission that any of the material referred to was part of the common general knowledge as at the priority date of the application.

Existing commonly available trip planners primarily focus on matching travellers immediate needs to services. There appear to be no commonly available trip planners that provide functionality to learn of travellers interests and preferences based on a persistent memory of their choices.

Further, there appear to be no trip planners that provide functionality to suggest locations that are aligned with a particular travellers evolving interests and preferences.

Similarly, there appear to be no trip planners that provide a means of distributed trip planning collaboration in real time between different travellers, trips, interests and preferences, while providing location information and suggested alternatives.

Algorithms exist that attempt optimal matching in the face of multiple variable preferences. Classic examples are matching multiple students and multiple preferences for study to multiple universities and multiple courses. With these, however, there are no learning components as there are no future decisions that are tracked.

Algorithms also exist to deduce interest trends of large populations by correlating choices and behaviour of statistically large groups. Amazon uses this in their book shop to suggest other books based on what other people bought who also bought the item of interest. The learning component, however, is limited to what large groups have done in a similar situation and not a matching of individual preference.

Further, algorithms exist to select by parameter from a list of items. Shopping sites use this to allow consumers to narrow down their search category by category; eg: size, price, features. In these algorithms, however, there are no learning components as there are no future decisions that are tracked.

Existing trip planners are primarily concerned with the short term commercial transaction of selling access to services either directly or indirectly at locations during a trip. This focus largely trends away from seeking to better understand the long term evolution of behaviour of a specific traveller by observing a sequence of their decisions over time. Travellers are generally expected to know where they want to go and what they want to do.

At present, there seems to be a paucity of available processes and systems that permit travel advisory services to be performed with a persistent and long term community of travellers.

### DISCLOSURE OF THE INVENTION

It is an object of the present invention to profile users of a database and provide predictive information based on their interaction with the database with a view to overcoming or mitigating some or all of the problems or limitations associated with previous methods and systems that attempt same.

In accordance with one aspect of the present invention, there is provided a method for analysing interests of a persona in a prescribed domain, the persona interacting with a repository of information containing: items that may embody one or more interests of a persona in that domain, categories that are a collection of all possible interests of a persona relative to that domain, and values that constitute a measure of the quality or quantity prescribed for each interest; the method comprising:

creating a category/item database including: items, categories of interests for each item and values of those interests prescribed for each item; and

generating a persona interest database from the category/item database for providing items with categories of interest for a persona having regard to one or any combination of a persona's:
(1) evaluation of the categories of particular items designated by the persona;
(2) accessing of a particular item or a category of a particular item accessed by the persona;
(3) declared interests.

Preferably, the category/item database is created by:
(i) determining a generic set of discrete categories of interests for each item based upon the inherent characteristics of each item;
(ii) calculating a value for each category of interest for each item, the value being a relative rating based upon a generic assessment of the measure of that interest as it applies to the particular item to which the interest is being prescribed; and
(iii) generating a category profile for each item based on the determined categories of interest and the value calculated for each category of interest applicable to the item.

Preferably, regard of the evaluation of the categories of a particular item by the persona includes receiving evaluation data from the persona, rated according to the same measurement criteria applied to the particular category of interest used for calculating a value for the category of interest of the particular item in the category/item database, and combining the rated evaluation data with the value of that interest applied to the particular item as derived from the category/item database in accordance with a prescribed evaluation function.

Preferably, regard of the accessing of an item by the persona includes receiving actual access data from the persona or sources independent of the persona pursuant to the persona accessing the particular item and calculating a list of observed interests of the persona based on the category profile of the item derived from the category/item database according to the actual access data.

Preferably, regard of the declared interests of the persona includes receiving declared interest data from the persona for categories of interest nominated by the persona, rated according to the same measurement criteria applied to the particular categories of interest in the category/item database, and combining the rated declared interest data with the value of those interests derived from the category/item database for all of those items evaluated or accessed by the persona, in accordance with a prescribed declaration of interest function.

In accordance with an alternative to the preceding aspect of the invention, there is provided a method for analysing in a prescribed domain the interests of a persona interacting with a repository containing information that may serve those interests, including:

(a) generating results from the following process steps:
(i) defining a persona who is an individual or a group of individuals who share a common behaviour or intent;
(ii) defining an item which is an embodiment of an interest to a persona; (iii) defining categories that are collections of interests of persona; (iv) defining measures which are numerical values representative of the relative interest of a persona for a category;
(v) for each persona, recording one or more declared interests as numerical values representing relative rankings as declared by each persona;
(vi) for each persona, recording actual or planned access to items;
(vii) recording persona evaluations of items;

(b) performing the following steps based on those results:
(i) defining groups each containing a range of measures;
(ii) allocating numerical values to each group in proportion to the measure or range of measures contained in that group;
(iii) tabulating and recording for each category/item combination the numerical value allocated to the group containing the measure of that category/item combination;
(iv) for each tabulated category/item, adjusting numerical values as a combination of the calculated group values at step (b)(iii) and persona evaluations at step (a)(vii);
(v) for each persona calculating and recording as interests for each category the combination of declared interests at step (a)(v) and category/item numerical values at step (b)(iv) of items accessed.

In accordance with another aspect of the invention, there is provided a method for analysing preferences of a persona in a prescribed domain who interacts with a repository containing: items that may embody one or more interests of a persona in that domain, relationships between the items, and attribute values that constitute a measure of the quality or quantity prescribed for each relationship; the method including:

creating an item relationship database including: items where an item may also include a set of items, attributes indicative of relationships between items and attribute values of those relationships prescribed for each linking of items; and

generating a persona preference database from the item relationship database for providing preferences of items for a persona having regard to either or both of a persona's:
(1) accessing of sets of items;
(2) declared preferences.

Preferably, the item relationship database is created by:
(i) determining a generic set of discrete relationship attributes between each linking of items based upon the inherent characteristics of each item;
(ii) calculating an attribute value for each attribute relationship between each linking of items, the attribute value being a relative measure of the particular attribute relationship between each linking of items;
(iii) generating an attribute relationship profile for each linking of items based on the determined attributes for the linking of items and the attribute value calculated for each attribute, relationship applicable to the linked items.

Preferably, regard of the accessing of sets of items by the persona includes receiving actual access data from the persona or sources independent of the persona pursuant to the persona accessing a particular set of items and calculating a list of observed preferences of the persona based on the attribute relationship profile of each linked item within the particular set of items, the attribute relationship profile being derived from the item relationship database according to the actual access data.

Preferably, regard of the declared preferences of the persona includes receiving declared preference data from the persona for relationship attributes nominated by the persona, rated according to the same measurement criteria applied to the particular attribute relationship in the item relationship database, and combining the rated declared interest data with the value of those attribute relationships derived from the item relationship database for all of those items accessed by the persona, in accordance with a prescribed declaration of preference function.

In accordance with an alternative to the preceding aspect of the invention, there is provided a method for analysing the preferences of a persona interacting with a repository containing information that may serve those interests, including:

(a) generating results from the following process steps:
(i) defining attributes that are numerical values measuring relationships between items;
(ii) for each persona, recording one or more declared preferences as numerical values measuring item attributes;
(iii) for each persona, recording access to items into one or more sets and where appropriate the ordering of those items in a set;

(b) performing the following steps based on those results:
(i) for each persona, calculating and recording as preferences for each attribute the combination of the declared preferences as generated at step (a)(ii) and calculated attribute values of item relationships in sets accessed.

In accordance with a further aspect of the invention, there is provided a method for suggesting items in a prescribed domain that are aligned with the predetermined interests and preferences of a persona stored in a repository of information in response to an item plan access of a persona interacting with the repository, the repository including: items that may embody one or more interests of a persona in that domain, categories that are a collection of all possible interests of a persona relative to that domain, values that constitute a measure of the quality or quantity prescribed for each interest, relationships between the items, and attribute values that constitute a measure of the quality or quantity prescribed for each relationship; the method including:

calculating a set of preferred items for the persona based on previous analysis of the preferences of the persona as stored in the repository that are not in a planned set of items of the persona; and selecting items with the highest relative interest from the set of preferred items as item suggestions.

Preferably, calculating the set of preferred items includes:
(i) receiving item plan access data comprising a set of items planned for a persona;
(ii) selecting a candidate set of items calculated to not be in the planned set of items;
(iii) reducing the candidate set to those items that have attribute values within a threshold relative to the predetermined preferences of the persona for each relationship between the items.

Preferably, selecting the candidate set as suggestions includes:
(i) calculating the relative interest of the persona for each item in the candidate set as a function of a recorded interest of the persona for each category/item combination and recorded values of the category interest for each category/item combination; and
(ii) selecting from the candidate set as suggestions those items with the highest values of relative interest

Preferably, the recorded interest of the persona is derived from a persona interest database generated according to the method of the one aspect of the invention.

Preferably, the predetermined preferences of the persona are derived from a persona preference database generated according to the method of the other aspect of the invention.

Preferably, the function of a recorded interest of the persona and the recorded values of each category/item combination comprises the sum of multiplying the recorded interest of the persona for each category/item combination by the recorded numerical values of each category/item combination.

In accordance with an alternative to the preceding aspect of the invention, there is provided a method for suggesting items aligned with the interests, preferences and planned item access of a user interacting with a database containing information that may serve those interests, including:

(a) generating results from the following process steps:
(i) analysing the interests of personas using the method as defined in the one aspect of the invention;
(ii) analysing the preferences of personas using the method as defined in the another aspect of the invention;

(b) performing the following steps based on those results:
(i) for each persona, recording persona planned access to items and the ordering of items in one or more sets;
(ii) for each persona, selecting a candidate set of items not in the planned set;
(iii) reducing the candidate set to those items that have attributes within a threshold relative to the preferences of a persona for each attribute;
(iv) calculating the relative interest of the persona for each item in the candidate set as the sum of multiplying the recorded interest of the persona for each category/item combination by the recorded numerical values of each category/item combination;
(v) selecting from the candidate set those items with the highest values of relative interest as derived from step (b)(iv)).

In accordance with still another alternative to the preceding aspect of the invention, there is provided a method for suggesting items in a prescribed domain that are aligned with the interests and preferences of a user based on the interests and preferences of persona stored in a repository of information in response to an item plan access of the user interacting with the repository, the repository including: items that may embody one or more interests of a persona in that domain, categories that are a collection of all possible interests of a persona relative to that domain, values that constitute a measure of the quality or quantity prescribed for each interest, relationships between the items, and attribute values that constitute a measure of the quality or quantity prescribed for each relationship; the method including;

calculating a set of preferred items for the user based on previous analysis of the preferences of the persona as stored in the repository that are not in a planned set of items of the persona; and

selecting items with the highest relative interest from the set of preferred items as item suggestions.

Preferably, the method of calculating the set of preferred items includes:
(i) receiving item plan access data comprising a set of items planned for the user;
(ii) selecting a candidate set of items not in the planned set of items;
(iii) reducing the candidate set to those items that have attribute values within a threshold relative to preferences of the user derived from the item plan access data for each relationship between the items.

Preferably, the method of selecting the candidate set as suggestions includes:
(i) calculating the relative interest of the user for each item in the candidate set as a function of a recorded interest of the user for each category/item combination and recorded values of the category interest for each category/item combination; and
(ii) selecting from the candidate set as suggestions those items with the highest values of relative interest.

In accordance with a still further aspect of the invention, there is provided a method for sharing user plans, activity and experiences with communities of users interacting with a database containing information that may serve those interests, including:

(a) generating results from the following process steps:
(i) recording planned item access and suggested items derived from the methods as defined in the further aspect of the invention;
(ii) defining communities of personas sharing common interests and/or preferences;
(iii) recording persona memberships of communities;
(iv) recording persona evaluations of items;
(v) recording persona comments about items;
(vi) recording descriptions of items;
(vii) recording the current location of a persona;
(viii) recording the current date and time;
(ix) recording trusted persona evaluations of items;

(b) performing the following steps based on those results:
(i) displaying items planned to be accessed for the user making an enquiry;
(ii) displaying suggested items for the user making the enquiry;
(iii) optionally displaying item sets where date and time items are accessible fall within the date and time range chosen by a user making an enquiry;
(iv) optionally displaying item sets from personas where personas are members of a common community with a user making an enquiry;
(v) optionally displaying item sets from personas where those personas have actual/planned access within the date and time range chosen by a user making an enquiry;
(vi) optionally displaying item sets from trusted personas;
(vii) optionally displaying lines which may indicate the order direction connecting items in a set in their chosen order;
(viii) optionally displaying items being accessed by other personas at the current date and time;
(ix) optionally displaying one or more item descriptions, comments and evaluations;
(x) optionally display items distinctively for one or more of:
   item set, item category, item attribute, item date and time accessible, item evaluation, item access count, persona community membership, trusted persona.

In accordance with another aspect of the present invention, there is provided a system for analysing in a prescribed domain interests of a persona who interacts with a repository of information containing: items that may embody one or more interests of a persona in that domain, categories that are a collection of all possible interests of a persona relative to that domain, and values that constitute a measure of the quality or quantity prescribed for each interest; the system including:

a category/item database comprising: items, categories of interests for each item and values of those interests prescribed for each item;

a process for determining a set of discrete categories of interests for each item based upon the inherent characteristics of each item;

a process for calculating a value for each category of interest for each item, the value being a relative rating based upon a generic assessment of the measure: of that interest as it applies to the particular item to which the interest is being prescribed;

a process for generating a category profile for each item based on the determined categories of interest and the value calculated for each category of interest applicable to the item;

a persona interest database for providing items with categories of interest for a persona having regard to one or any combination of a persona's:
(1) evaluation of the categories of particular items designated by the persona;
(2) accessing of a particular item or a category of a particular item accessed by the persona;
(3) declared interests.

In accordance with a further aspect of the invention, there is provided a system for analysing in a prescribed domain preferences of a persona who interacts with a repository containing: items that may embody one or more interests of a persona in that domain, relationships between the items, and attribute values that constitute a measure of the quality or quantity prescribed for each relationship; the system including:

an item relationship database including: items where an item may also include a set of items, attributes indicative of relationships between items and attribute values of those relationships prescribed for each linking of items, a process for determining a generic set of discrete relationship attributes between each linking of items based upon the inherent characteristics of each item;

a process for calculating an attribute value for each attribute relationship between each linking of items, the attribute value being a relative measure of the particular attribute relationship between each linking of items;

a process for generating an attribute relationship profile for each linking of items based on the determined attributes for the linking of items and the attribute value calculated for each attribute relationship applicable to the linked items; and a persona preference database for providing preferences of items for a persona having regard to either or both of a persona's:
(1) accessing of sets of items;
(2) declared preferences.

In accordance with still a further aspect of the invention, there is provided a system for suggesting items in a prescribed domain that are aligned with the predetermined interests and preferences of a persona stored in a repository of information in response to an item plan access of a persona interacting with the repository, the repository including: items that may embody one or more interests of a persona in that domain, categories that are a collection of all possible interests of a persona relative to that domain, values that constitute a measure of the quality or quantity prescribed for each interest, relationships between the items, and attribute values that constitute a measure of the quality or quantity prescribed for each relationship; the system including:

a process for receiving item plan access data comprising a set of items planned for a persona;

a process for selecting a candidate set of items calculated to not be in the planned set of items;

a process for reducing the candidate set to those items that have attribute values within a threshold relative to the predetermined preferences of the persona for each relationship between the items;

a process for calculating the relative interest of the persona for each item in the candidate set as a function of a recorded interest of the persona for each category/item combination and recorded values of the category interest for each category/item combination; and

a process for selecting from the candidate set as suggestions those items with the highest values of relative interest.

In accordance with another aspect of the present invention, there is provided a system for suggesting items in a prescribed domain that are aligned with the predetermined interests and preferences of a user based on the interests and preferences of persona stored in a repository of information in response to an item plan access of a persona interacting with the repository, the repository including: items that may embody one or more interests of a persona in that domain, categories that are a collection of all possible interests of a persona relative to that domain, values that constitute a measure of the quality or quantity prescribed for each interest, relationships between the items, and attribute values that constitute a measure of the quality or quantity prescribed for each relationship; the system including:

a ‘calculate candidate set using preferences’ process to calculate a set of preferred items for the persona based on previous analysis of the preferences of the persona as stored in the repository that are not in a planned set of items of the persona; and

a ‘calculate candidate set using interests’ process to select items with the highest relative interest from the set of preferred items as item suggestions.

### BRIEF DESCRIPTION OF THE DRAWINGS

The invention is described in the subsequent mode for carrying out the invention with reference to the accompanying drawings, wherein:

FIG. 1 is schematic diagram showing an overview of the profiling system;

FIG. 2 is a block diagram showing how the various modules inter-relate to provide the various functions performed by the profiling system;

FIG. 3 is a data flow chart showing the operation of the research analysis module;

FIG. 4 is a data flow chart showing the operation of the analyse module;

FIG. 5 is a data flow chart showing the operation of the suggestion module;

FIG. 6 is a data flow chart showing the operation of the outcomes communication module;

FIG. 7 is a diagrammatic flow chart showing an example of processes generated and steps performed as represented by the pseudo code for the analyse module in accordance with the first embodiment.

### BEST MODE(S) FOR CARRYING OUT THE INVENTION

The best mode for carrying out the invention is described with respect to two specific embodiments of the invention—the first being directed towards a travel planning domain that allows travellers to plan their trips within a particular geographical area such as Australia, Australasia or global; and the second being directed towards a food domain that allows consumers to choose recipes and buy ingredients for preparing meals that they or their friends or family would find particularly appealing.

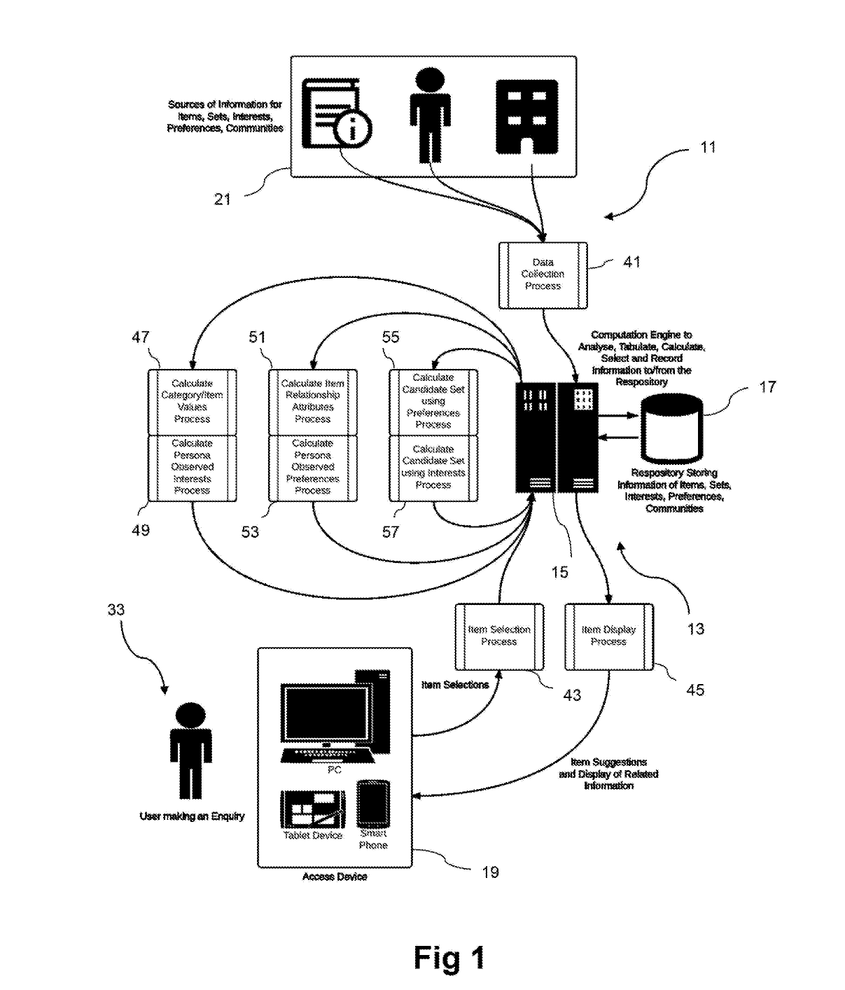

Both embodiments are implemented in a computer network environment provided by way of the Internet as shown in FIG. 1 of the drawings. Of course the invention is not limited to being implemented in this manner and other embodiments may involve implementation of the invention in a closed intranet environment or even in a standalone computer environment.

As shown in FIG. 1, the embodiments are synthesised by way of a user profiling system 11 having a central server arrangement 13, including a computation engine 15 and a repository 17, a plurality of clients in the form of different types of access devices 19 and information sources 21, and a plurality of processes that are operated by the computation engine 15 and/or access devices 19.

The computation engine 15 generally includes processes to analyse, tabulate, calculate, select and record information to and from the repository 17. The repository 17 comprises a series of databases for storing information in the form of items, sets, interests, preferences, evaluations, access data, date/time accessible data, item planned access, communities and any other type of data that may be suitable for the purpose of other modes of the invention. In the present mode, the databases include an item database 23, a category/item database 25, a persona interest database 27, an item relationship database 29 and a persona preference database 31. Furthermore, in a particular implementation of this mode, the databases also include an evaluations database, an item access database, an item plans database etc (not shown), depending upon how the database implementation would be preferred to be structured.

The access devices 1 are of any convenient form of intelligent device that can be operated by a user 33 and interface with a network to communicate with the central server arrangement 13 of the profiling system 11. Typically, an access device is a personal computer PC 35, a tablet device 37 or a Smart Phone 39.

The information sources 21 are any form of media that can be interfaced with the network of the profiling system 11 to provide information for items, sets, interests, preferences and/or communities relative to a persona. For example, an information source may be a shop, a dub, a caravan park, a library, GPS device recording persona location, financial records, an accommodation site that has been frequented or attended by a persona, etc.

High level processes that form part of the profiling system and interface with the clients include a data collection process 41, an item selection process 43 and an item display process 45. The data collection process 41 is programmed to receive information in the form of data from the various information sources 21, and input this data to the central server arrangement 13. The item selection process 43 is programmed to receive item selections input by a user in response to a query from any of the different types of access devices 19 and input the item selections to the central server arrangement 13 for processing. The item display process 45 is programmed to receive the output of item suggestions and other related display data from the central server arrangement 13 following processing in response to the input of item selections of a user, and input this display data into the corresponding access device of the user making the enquiry.

Other processes operated by the computation engine 15 and which are dedicated to performing particular functions that will be described in more detail later, include:
(i) a calculate category/item values (CCIV) process 47 and calculate persona observed interests (CPOI) process 49 that form part of a research analysis module 50;
(ii) a calculate item relationship attributes (CIRA) process 51 and calculate persona observed preferences (CPOP) process 53 that form part of an analyse module 54; and
(iii) a calculate candidate set using preferences (CCSUP) process 55 and calculate candidate set using interests (CCSUI) process 57 that form part of a suggestion module 58.

As will be described in more detail later, further processes are operated by the computation engine 15 that form part of a communicate module 60.

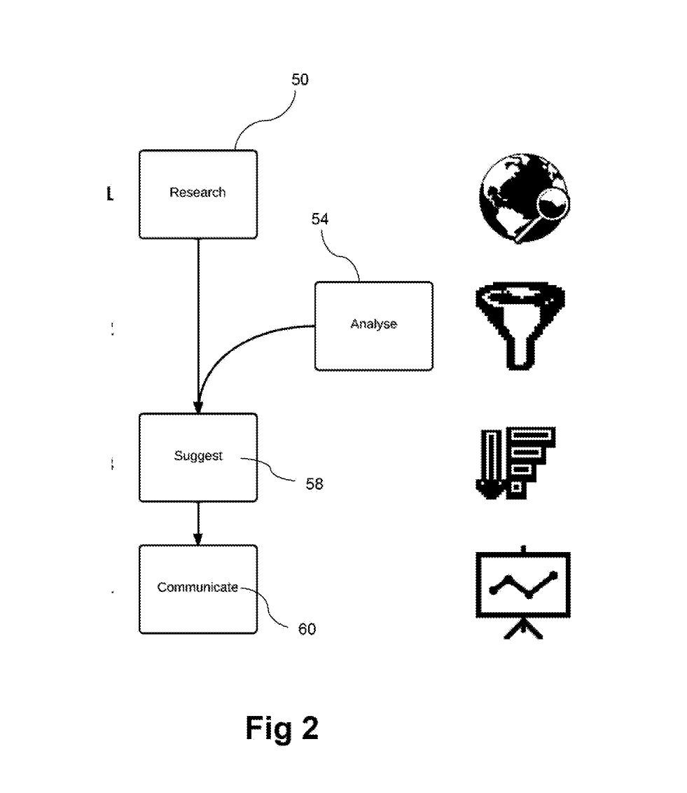

As shown in FIG. 2 of the drawings, the research analysis module 50, analyse module 54, suggestion module 58 and communicate module 60, operate interdependently and in combination with each other to provide different functions for the benefit of persona who effectively are members of the profiling system 11 and users 33 who may be persona or persons who are contemplating to become a member of the profiling system.

The research analysis module 50 performs the function of creating the item database 23, then from this the category/item database 25 and then finally generating the persona interest database 27 for the purpose of analysing the interests of persona relative to the particular domain for which the profiling system 11 is implemented. This is achieved intrinsically by virtue of the data structures adopted for the databases and the processes operating continuously in response to interactions with the profiling system 11 by persona using access devices 19 to evaluate and access items and declare interests, and input from the information sources 21 pursuant to persona accessing items.

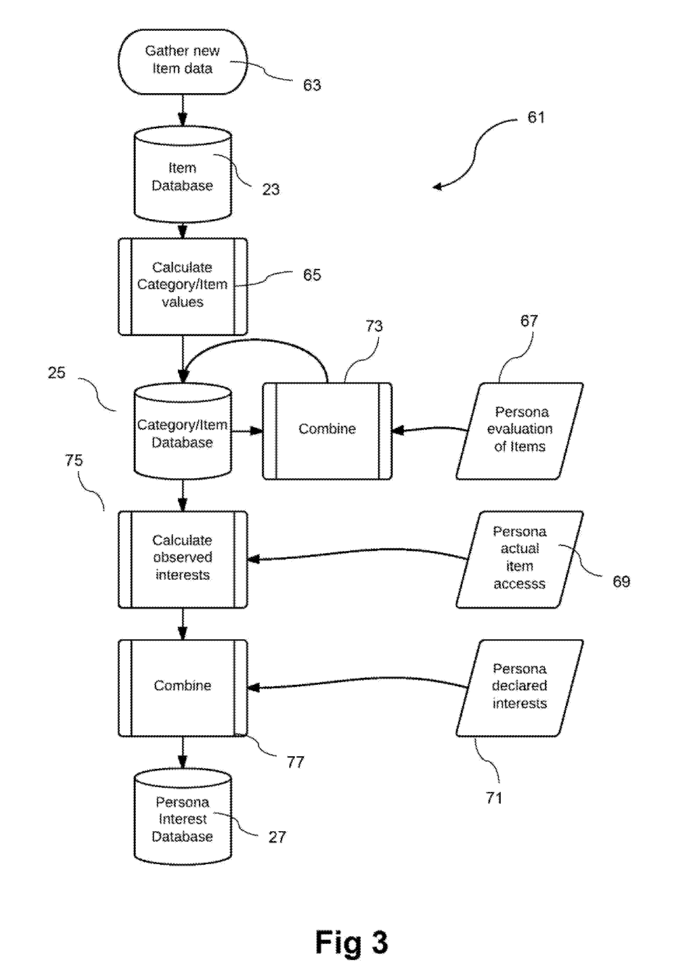

As shown in FIG. 3, the research analysis module 50 is implemented in computer software that follows a program data flow 61 where new item data is gathered initially at step 63 to create the item database 23. Category/item values are then calculated at step 65 using the CCIV process 47 for each item stored in the item database 23 to create the category/item database 25. The category/item database has a data structure mapping items, categories of interests for each item and values of those interests that are prescribed for each item.

Thus the CCIV process 47 includes a categories process for determining a set of discrete categories of interests for each item based upon the inherent characteristics of each item and a value process for calculating a value for each category of interest for each item, whereby the value is a relative rating based upon a generic assessment of the measure of that interest as it applies to the particular item to which the interest is being prescribed. In some instances the value is qualitative and in others it is quantitative, depending upon the particular character of the interest in question.

From this the CCIV process 47 provides a profiling process that generates for each item a category profile based on the determined categories of interest and the value calculated for each category of interest applicable to the item.

The persona interest database 27 is generated from the category/item database 25 to provide items with categories of interest for each persona having regard to the particular persona's:
evaluation of the categories of particular items designated by the persona as sourced at step 67;
accessing of a particular item or a category of a particular item accessed by the persona as sourced at step 69; and
declared interests at step 71.

It should be appreciated that in other modes only one of steps 67 to 71 is invoked, and in further modes, different combinations of the steps are invoked, depending upon the particular domain or result to be achieved.

In the present mode, the persona evaluation of items sourced at step 67 involves an evaluation process programmed to receive evaluation data from the persona, rated according to the same measurement criteria applied to the particular category of interest used for calculating a value for the category of interest of the particular item in the category/item database 25. The rated evaluation data is then combined by the evaluation process at step 73 with the value of that interest applied to the particular item as derived from the category/item database 25 in accordance with a prescribed evaluation function, which will be described in more detail later.

The persona actual item access sourced at step 69 involves an accessing process programmed to receive actual access data from the persona or sources independent of the persona as represented by the information sources 21, pursuant to the persona accessing the particular item. The observed interests of the persona are then calculated at step 75 using the CPOI process 49 based on the category profile of the item derived from the category/item database 25 according to the actual access data received from the information source 21.

The persona declared interest sourced at step 71 involves a declared interests process programmed to receive declared interest data from the persona for categories of interest nominated by the persona, rated according to the same measurement criteria applied to the particular categories of interest in the category/item database 25. The rated declared interest data is then combined by the declared interests process at step 77 with the value of those interests derived from the category/item database 25 for all of those items evaluated or accessed by the persona, in accordance with a prescribed declaration of interest function that will also be described in more detail later.

The software implementation of the research analysis module 50 is more particularly described by way of the following pseudo code, which generates results from the following processes:

1(a)(i): define categories that are collections of items with common characteristics;

1(a)(ii): define measures which are numerical values representative of the relative interest for a category;

1(a)(iii): for each persona, record one or more declared interests as numerical values representing measures for a category;

1 (a)(iv): for each persona, record access to items;

1(a)(v): for each persona, record evaluations of items; and performs the following steps based on those results:

1(b)(i): define groups each containing a range of measures;

1(b)(ii): allocate numerical values to each group in proportion to the range of measures contained in that group;

1(b)(iii): tabulate and record for each category/item combination the numerical value allocated to the group containing the measure of that category/item combination;

1(b)(iv): for each tabulated category/item, adjust numerical values as a combination of the calculated group values (ref process 1(b)(iii)) and persona evaluations (ref process 1(a)(v));

1(b)(v): for each persona, calculate and record as interests for each category the combination of declared interests (ref process 1(a)(iii)) and category/item numerical values (ref process 1(b)(iv)) of items accessed.

Psuedo code for research analysis module 50:

```
Define items:
  item = {i1, i2, i3, ...}
Define personas:
  persona = {p1, p2, p3, ...}
1(a)(i)
Define item categories:
  category = {c1, c2, c3, ...}
1(a)(ii)
For each category, define a function used to calculate a measure representative of the relative
interest of an item:
  f_{c}(category, item)
1(a)(iii)
For each persona ‘p’, record the personas declared interest for each category:
  persona.interest[category]ₚ = [interest(c1), interest(c2), interest(c3), ...]
1(a)(iv)
For each persona ‘p’, record the sets of items accessed:
  item.accessedₚ = {s1, s2, s3, ...}
For each set ‘s’, record the items accessed:
  item.accessedₛ = {i1, i2, i3, ...}
For each persona ‘p’, record the items accessed:
  item.accessed.allₚ = ∪_{for all item.accessed}_{ₚ} item.accessedₛ
1(a)(v)
For each persona ‘p’, record the persona evaluations of items:
  $persona . {evaluation [ catagory , item . accessed . {all}_{p} ]}_{p} = [ \begin{matrix}evaluation ( c 1 , i 1 ) & evaluation ( c 2 , i 1 ) & … \\ evaluation ( c 1 , i 2 ) & evaluation ( c 2 , i 2 ) & … \\ ⋮ & ⋮ & ⋱\end{matrix} ]$
1(b)(i)
Define interest.groups g1, g2, g3, ... with interest.value thresholds a, b, c, ... :
```

| | |
|---|---|
| g(interest value) = | CASE interest.value OF |
| | 0 < measure < a: g1 |
| | a < measure < b: g2 |
| | b < measure < c: g3 |
| | ... |
| | ENDCASE |

1(b)(ii)
Define interest.group.values gv1, gv2, gv3, ... associated with interest.groups g1, g2, g3, ... :

| | |
|---|---|
| gv(interest.group) = | CASE interest.group OF |
| | g1: gv1 |
| | g2: gv2 |
| | g3: gv3 |
| | ... |
| | ENDCASE |

```
  1(b)(iii)
  Record the calculated interest.group.values for all combinations of categories and items:
    $group . value [ category \text{,} item ] = [ \begin{matrix}gv ( g ( {f}_{c} ( c 1 , i 1 ) ) & gv ( g ( {f}_{c} ( c 2 , i 1 ) ) & … \\ gv ( g ( {f}_{c} ( c 1 , i 2 ) ) & gv ( g ( {f}_{c} ( c 2 , i 2 ) ) & … \\ ⋮ & ⋮ & ⋱\end{matrix} ]$
  1(b)(iv)
  Record the revised interest values as the combination of calculated and evaluated group
values of categories and items:
  FOR all categories
    FOR all items
      group.value′[category,item] =
  $\frac{group . value [ category \text{,} item ] + \frac{{\sum }_{for all persona} persona . {evaluation [ category \text{,} item ]}_{p}}{\# of personas} * ( n - 1 )}{n}$
NB: weighted average used as an example of the combination, where ‘n’ is the weight used
NB: other methods include moving average, Bayesian filtering, Kalman filters
1(b)(v)
For each persona ‘p’, record the revised persona interests as the combination of declared and
accessed item interest values:
  FOR all categories
persona.interest′[category]ₚ =
$\frac{persona . {interest [ category ]}_{p} + \frac{{\sum }_{for all item . accessed . {all}_{p}} group . {value}^{′} [ category \text{,} item ]}{\# of item . accessed . {all}_{p}} * ( n - 1 )}{n}$
```

NB: weighted average used as an example of the combination, where ‘n’ is the weight used.
NB: other methods include moving average, Bayesian filtering, Kalman filters.

The analyse module 54 performs the function of creating the item relationship database 29 from the item database 23 and then the persona preference database 31 for the purpose of analysing the preferences of persona relative to the particular domain for which the profiling system 11 is implemented. Again this is achieved intrinsically by the data structures adopted for the databases associated with the analyse module 54 and the processes operating continuously in response to interactions with the profiling system 11 by persona using access devices 19 to access sets of items and declare preferences, and input from the information sources 21 pursuant to persona accessing these sets of items.

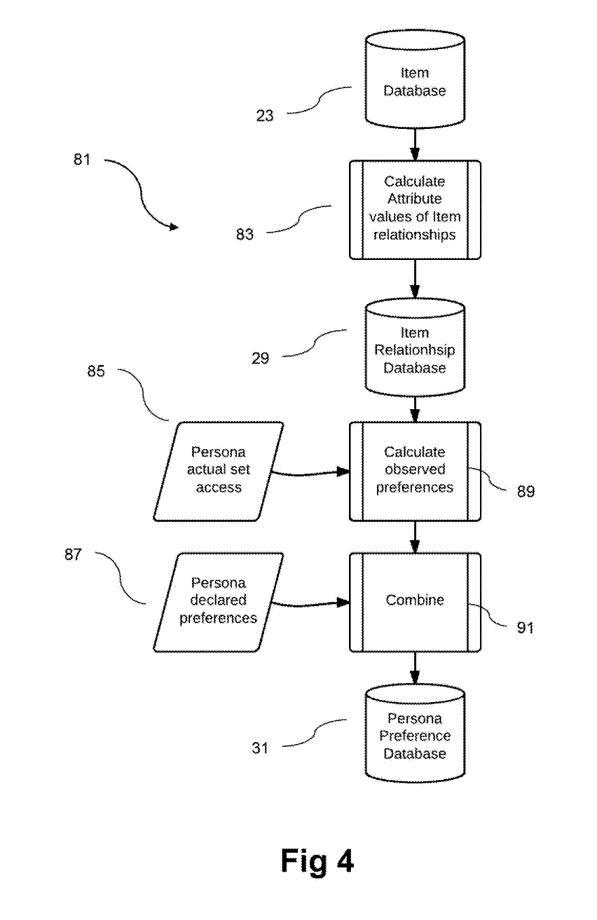

As shown in FIG. 4, the analyse module 54 is implemented in computer software that follows a program data flow 81 where the item database 23 provides a source for calculating attribute values of item relationships at step 83 using the CIRA process 51 to create the item relationship database 29.

The item relationship database 29 has a data structure mapping items that embody one or more interests of a persona, relationships between the items, attributes indicative of these relationships and attribute values that are numerical values measuring the relationships between all linked items. Items may be linked in couples or in numbers greater than a couple, depending upon the particular characteristics of the domain.

Thus the CIRA process 51 includes a process for determining a set of discrete relationship attributes between each linking of items based upon the inherent characteristics of the relationship between the items. The relationship attributes can be either quantitative or qualitative, depending upon the character of the relationship in question.

The LIRA process 51 then provides a process for calculating the attribute value for each attribute relationship for each linking of items. The attribute value is a relative measure of the particular attribute relationship between each of the linking items.

From this the CIRA process 51 provides a process for generating an attribute relationship profile for each of the linking items based on the determined attributes for these items. The attribute value is then calculated for each attribute relationship applicable to the linking items to create the item relationship database 29.

The persona preference database 31 is generated from the item relationship database 29 to provide preferences of items for a persona having regard to either or both of a persona's:
accessing of sets of items at step 85; and
declared preferences at step 87.

In other modes, only one of steps 85 or 87 is invoked, whereas in the present mode, both steps are invoked.

The persona actual set access sourced at step 85 involves an actual set access process programmed to receive actual access data from the persona or sources independent of the persona pursuant to the persona accessing a particular set of items. The list of observed preferences of the persona is then calculated at step 89 using the CPOP process 53 based on the attribute relationship profile of each linking items within the particular set of items. The attribute relationship profile is derived from the item relationship database 29 according to the actual access data.

The persona declared preferences sourced at step 87 involves a declared preference process programmed to receive declared preference data from the persona for relationship attributes nominated by the persona. This declared preference data is rated according to the same measurement criteria applied to the particular attribute relationship in the item relationship database 29. The rated declared interest data is then combined by the declared preference process at step 91 with the value of those attribute relationships derived from the item relationship database for all of those items accessed by the persona, in accordance with a prescribed declaration of preference function, which will be described in more detail later.

The software implementation of the analyse module 54 is more particularly described by way of the following pseudo code, which generates results from the following processes:

2(a)(1) define attributes that are numerical values measuring relationships between items;

2(a)(ii) for each persona, record one or more declared preferences as numerical values measuring item attributes;

2(a)(iii) for each persona, record access to items into one or more sets and where appropriate the ordering of those items in a set; and performs the following steps based on those results:

2(b)(i) for each persona, calculate and record as preferences for each attribute the combination of the declared preferences (ref process 2(a)(ii)) and calculated attribute values of item relationships in sets accessed.

Pseudo code for analyse module 54:

```
2(a)(i)
Define item attributes measuring a relationship between items:
item.attribute = {a1, a2, a3, ...}
For each attribute, define a function used to calculate the value of that attribute for items in a set:
fₐ(attribute, itemₛ)
2(a)(ii)
For each persona ‘p’, record the personas declared preference for each attribute:
  persona.preference[attribute]ₚ = [preference(a1), preference(a2), preference(a3), ...]
2(a)(iii)
from 1(a)(iv) copied here for clarity
For each persona ‘p’, record the sets of items accessed:
    item.accessedₚ = {s1, s2, s3, ...}
For each set ‘s’, record the items accessed:
    item.accessedₛ = (i1, i2, i3, ...}
2(b)(i)
For each persona ‘p’, record the revised persona preferences as the combination of declared and
accessed items preference:
  FOR all attributes
persona.preference′[attribute]ₚ =
  $\frac{persona . {preference [ attribute ]}_{p} + \frac{{\sum }_{for all item . {accessed}_{p}} {f}_{a} ( attribute . {item}_{s} )}{\# of item . {accessed}_{p}} * ( n - 1 )}{n}$
NB: weighted average used as an example of the combination, where ‘n’ is the weight used
NB: other methods include moving average, Bayesian filtering, Kalman filters.
```

The suggestion module 58 performs the function of suggesting additional items to a persona that may be of relevant interest following the persona submitting an item plan having regard to previous analysis performed by the research analysis module 50 to identify interests and the analyse module 54 to identify preferences. Thus the suggestion module 58 provides item suggestions that are aligned with the predetermined interests and preferences of a persona based on previous analysis of the interests and preferences of the persona as stored in the repository 17 in the form of items that may embody one or more interests of the persona, categories that are collections of possible interests of the persona, values that constitute a measure of the quality or quantity prescribed for each interest, relationships between the items and attribute values that constitute a measure of the quality or quantity prescribed for each relationship.

Furthermore, the suggestion module includes a process so that once a matched set of items are selected by a persona, no further suggestions are calculated based on these same matches. Moreover, the process is programmed to selectively make further suggestions from the candidate set focusing on providing an unmet need by reducing the relative interest of categories that are well supplied to serve past matches.

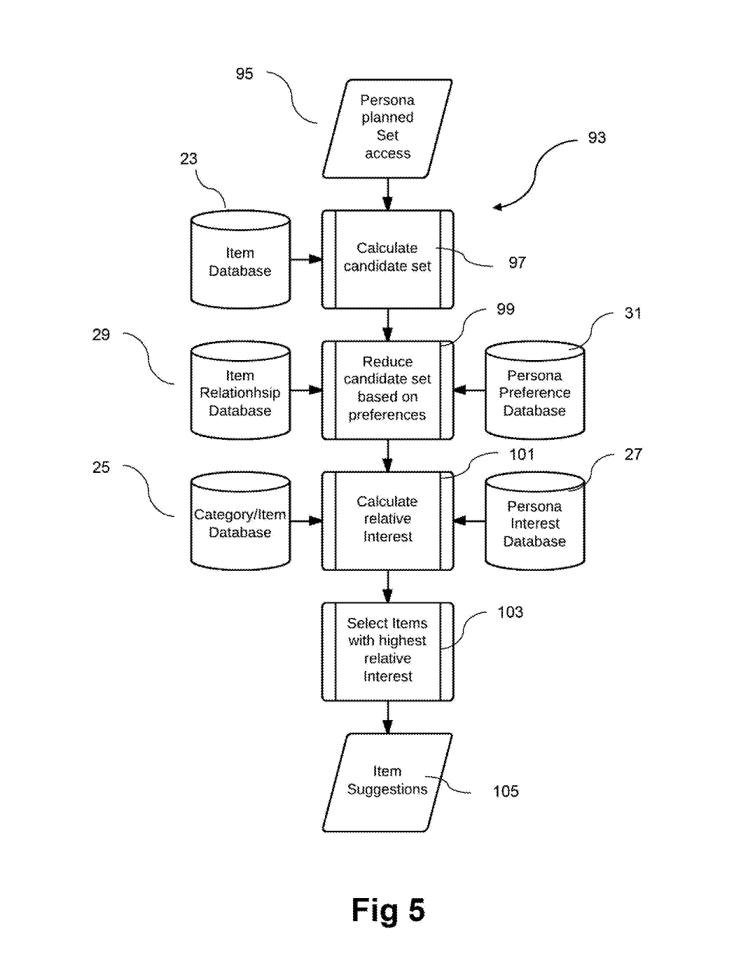

As shown in FIG. 5, the suggestion module 58 is implemented in computer software that follows a program data flow 93 where a persona planned set access at step 95 initiates operation of the suggestion module by an item plan process receiving item plan access data from the persona comprising a set of items planned for the persona.

In terms of data flow, a candidate set of items is selected from the item database 23 at step 97 using a candidate item process of the CCSUP process 55, whereby the candidate set is calculated to not be in the planned set of items received at step 95.

This candidate set is then reduced by a reduction process of the CCSUP process 55 to those items that have attribute values within a threshold relative to the predetermined preferences of the persona at step 99 for each relationship between the items as derived from the item relationship database 29 and the persona preference database 31.

The relative interest of the persona for each item in the reduced candidate set is then calculated by a calculation process at step 101 as a function of the recorded interest of the persona for each category/item combination derived from the category/item database 25 and the recorded values of the category interest for each category/item combination derived from the persona interest database 27.

This is achieved by using the CCSUI process 57 whereby the function of a recorded interest of the persona and the recorded values of the category interest for each category/item combination comprises the sum of multiplying the recorded interest of the persona for each category/item combination by the recorded numerical values of each category/item combination.

The CCSUI process 57 then includes a selection process for selecting items with the highest relative interest from the resultant candidate set at step 103 as item suggestions that are provided at step 105.

The software implementation of the suggestion module 58 is more particularly described by way of the following pseudo code, which generates results from the following processes:

3(a)(i) analyse the interests of personas using the method performed by the research analysis module 50;

3(a)(ii) analyse the preferences of personas using the method performed by the analyse module 54; and performs the following steps based on those results:

3(b)(i) for each persona, record persona planned access to items and the ordering of items in one or more sets;

3(b)(ii) for each persona, select a candidate set of items not in the planned set;

3(b)(iii) reduce the candidate set to those items that have attributes within a threshold relative to the preferences of a persona (ref 2(b)(i)) for each attribute;

3(b)(iv) calculate the relative interest of the persona for each item in the candidate set as the sum of multiplying the recorded interest of the persona for each category/item combination (ref 1(b)(v)) by the recorded numerical values of each category/item combination (ref 1(b)(iv));

3(b)(v) select from the candidate set as suggestions those items with the highest values of relative interest (ref 3(b)(iv)).

Pseudo code for the suggestion module 58:

```
3(a)(i)
  from 1(b)(v) copied here for clarity
  persona.interest’[category]ₚ
3(a)(ii)
  from 2(b)(i) copied here for clarity
  persona.preference’[attribute]ₚ
3(b)(i)
  For each persona ‘p’, record the sets of items planned to be accessed:
      item.plannedₚ = {s1, s2, s3, ...}
  For each set ‘s’, record the items planned to be accessed:
      item.plannedₛ = {i1 , i2, i3, ...}
3(b)(ii)
  Define the set of all possible items:
      item_{∪} = {i1, i2, i3, ...}
  For each persona ‘p’, record as the candidate set the items not planned to be accessed:
      item.candidateₚ = item_{∪} \ item.plannedₚ
3(b)(iii)
  For each persona ‘p’, revise the candidate set by excluding items whose attribute
relationships exceed a threshold relative to the persona preference:
  FOR all attributes
    item.candidate’ₚ =
      CASE Fₐ(item.candidateₚ)
      > persona.preference’[attribute]ₚ : exclude from item.candidate’ₚ set
      <= persona.preference’[attribute]ₚ : include in item.candidatep’ₚ set
      ENDCASE
3(b)(iv)
  from 1(b)(iv) copied here for clarity
  group.value’[category.item]
  For each persona ‘p’, record the relative interest of items in the candidate set:
    FOR all items in item.candidate’ₚ
      relative.interestₚ[item.candidate’ₚ]=
      Σ_{for all categories} persona. interest’[category]p x group.value’ [category.item]
3(b)(v)
  For each persona ‘p’, create a suggested set containing items in the upper ‘n’th percentile
of relative interest of items in the candidate set:
  FOR all items in item.candidate’ₚ
  item.suggestedₚ =
    CASE relative.interestₚ[item.candidate’ₚ]
    > nth percentile : include in item.suggestedₚ set
    <= nth percentile : exclude from item.suggestedₚ set
    ENDCASE
```

The suggestion module 58 is also adapted to provide item suggestions for users accessing the profiling system 11 who are not necessarily members of the system and thus do not have an analysed history of interests and preferences as do persona, but nonetheless can be provided with an indication of the power of the system to enable them to consider becoming a member and thus be a persona.

In this instance, the item suggestions provided are aligned with the interests and preferences of the user based on the interests and preferences of persona stored in the repository 17 or a default set of interests and preferences, as determined from plan access data input by the user.

The suggestion module 58 then proceeds in the same manner as with persona entered plan access data using the interests and preference of a default or randomly selected persona generated from the same plan access data, whereby the user would be presented with a reduced candidate set providing suggestions of those items with the highest values of relative interest.

The communicate module 60 performs a display function that permits persona plans, activity and experiences with communities of personas interacting with the repository 17 and those of trusted persona, based on receiving items planned to be accessed for a persona or user making an enquiry. Consequently, it is synthesised using much of the suggestion module 58.

In the case of trusted persona, provision is made for a persona to select other persona whom they trust or value the judgement and evaluation of. In such instances, the items, preferences and interests of the trusted persona, and their evaluation of these are added to the database items, preferences and interests of the persona. These are given an elevated ranking when calculating candidate set items for suggestions to the persona or user.

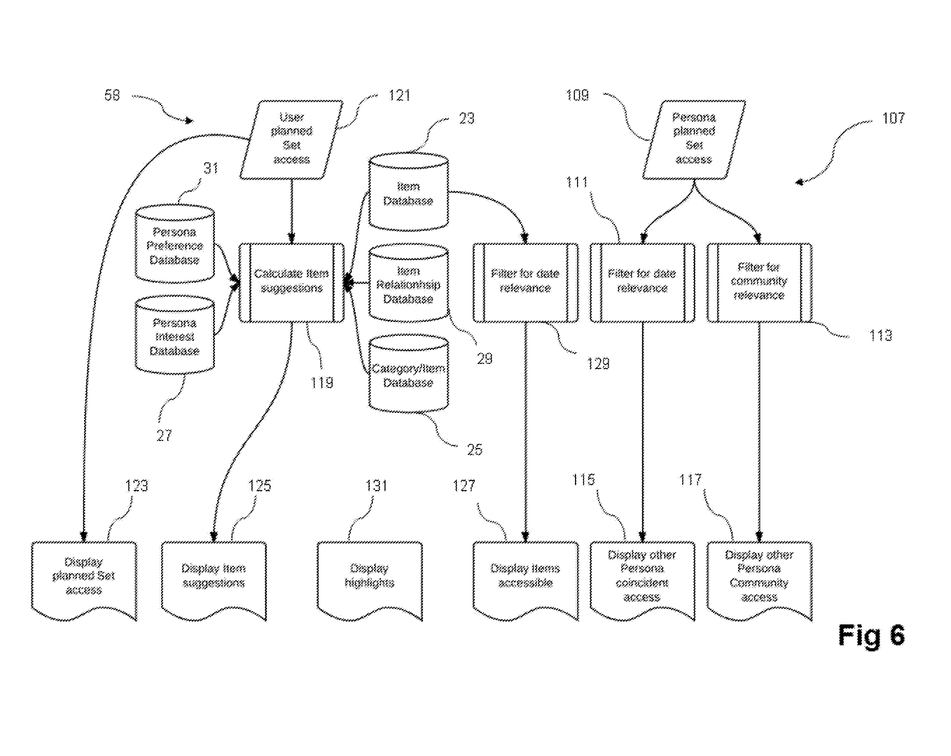

As shown in FIG. 6, the communicate module 60 is implemented in computer software that follows a program data flow 107 where a user planned set access at step 121 initiates operation of the communicate module by receiving item plan access data from the user comprising a set of items planned for the user.

Similarly, persona planned set access at step 109 separately receives item plan access data, which is filtered for date relevance at step 111 and community relevance at step 113 to respectively display other persona coincident access at step 115 according to the date and other persona community access at step 117, according to the community relevance of the persona.

The suggestion module 58 involving the item database 23, the category/item database 25, the persona interest database 27, the item relationship database 29 and the persona preference database 31 together with the various calculation processes shown consolidated by the calculate suggestion items step 119 is invoked by receiving user planned set access data at step 121 to perform various steps to display other options. These options include displaying the received planned set access data at step 123, item suggestions at step 125 as derived from the consolidated calculate item suggestions step 119, and items that are accessible at step 127 from the item database 23 after being filtered for date relevance at step 129.

A further option of displaying highlights of the planned trip is provided by step 131.

The software implementation of the communicate module 60 is more particularly described by way of the following pseudo code, which generates results from the following processes:

4(a)(i) record planned item access and suggested items derived from the methods as performed by the suggestion module 58;

4(a)(ii) define communities of personas sharing common interests and/or preferences;

4(a)(iii) record persona memberships of communities;

4(a)(iv) record persona evaluations of items;

4(a)(v) record persona comments about items;

4(a)(vi) record descriptions of items;

4(a)(vii) record the current location of a persona;

4(a)(viii) record the current date and time;

4(a)(ix)record trusted persona evaluations of items: and performs the following steps based on those results:

4(b)(i) display items planned to be accessed for the user making an enquiry;

4(b)(ii) display suggested items for the user making an enquiry (refer 3(b)(v));

4(b)(iii) optionally display item sets where date and time items are accessible fall within the date and time range chosen by a user making an enquiry;

4(b)(iv) optionally display item sets from personas where personas are members of a common community with a user making an enquiry;

4(b)(v) optionally display item sets from personas where those personas have actual/planned access within the date and time range chosen by a user making an enquiry;

4(b)(vi) optionally displaying item sets from trusted personas;

4(b)(vii) optionally display lines which may indicate the order direction connecting items in a set in their chosen order;

4(b)(viii) optionally display items being accessed by other personas at the current date and time;

4(b)(ix) optionally display one or more item descriptions, comments and evaluations;

4(b)(x) optionally display items distinctively for one or more of: item set, item category, item attribute, item date and time accessible, item evaluation, item access count, persona community membership, trusted persona.

Pseudo code for the communicate module 60:

```
4(a)(i)
  from 3(b)(i) copied here for clarity
  item.plannedₚ
  item.suggestedₚ
4(a)(ii)
  Define the persona communities:
    persona.community = {m1, m2, m3, ...}
4(a)(iii)
  For each community ‘m’, record the persona membership:
    persona.membershipₘ = {p1, p2, p3, ...}
4(a)(iv)
  from 1(a)(v) copied here for clarity
    persona.evaluation[category, item.accessed.allₚ]ₚ
4(a)(v)
  For each persona ‘p’, record comments about items accessed:
    item.comment[item.accessed,allₚ]ₚ = [comment(i1), comment(i2), comment(i3), ...]
4(a)(vi)
  Record descriptions for items:
    item.description[item_{∪}] = [description(i1), description(i2), description(i3), ...]
4(a)(vii)
  For each persona ‘p’, record the current persona location:
    persona.locationₚ
4(a)(viii)
  Record the current date and time:
    current.datetime
4(a)(ix)
  For each persona ‘p’, record the trusted persona evaluations of item:
    persona.evaluation[category, item.accessed.allₜₚ]ₜₚ = trusted persona
    $[ \begin{matrix}evaluation ( c 1 , i 1 ) & evaluation ( c 2 , i 1 ) & … \\ evaluation ( c 1 , i 2 ) & evaluation ( c 2 , i 2 ) & … \\ ⋮ & ⋮ & ⋱\end{matrix} ]$
4(b)(i)
  For the persona ‘p’ of the user making an enquiry, display items planned to be accessed:
  display(item.plannedₚ)
4(b)(ii)
  For the persona ‘p’ of the user making an enquiry, display suggested items:
  display(item.suggestedₚ)
4(b)(iii)
  Define a function which returns the set of date+time that an item is accessible:
    datetime.accessible(item) = {dt1, dt2, dt3, ...}
  Display all items within the enquiry date+time set:
    display( {item | item ε item_{∪} and datetime.accessible(item) ε enquiry} )
4(b)(iv)
  Define the set of persona sharing persona ‘p’ communities:
  persona.sharedₚ = {s | s ε persona , persona.membershipₚ ∩ persona.membershipₛ ≠ Ø }
  Display items sets from other persona sharing a community with the enquiring user persona:
  display( {item | item ε item.accessedₚ , p ε persona.sharedₚ } )
  display( {item | item ε item.plannedₚ , p ε persona.sharedₚ } )
4(b)(v)
  Define the set of all items planned for access by any persona:
    item.planned.all_{∪} = ∪_{for all persona} item.planned.allₚ
  Define a function which returns the set of date+time that an item is planned to be accessed:
    datetime.planned(item) = {dt1, dt2, dt3, ...}
  Display all items planned to be accessed within the enquiry date+time set:
    display( {item | item ε item.planned.all_{∪} , datetime.planned(item) ε enquiry} )
4(b)(vi)
  Define the set of all items planned for access by any trusted persona:
    item.planned.all_{∪} = ∪_{for all trusted persona} item.planned.allₚ
  Define a function which returns the set of date+time that an item is planned to be accessed:
    datetime.planned(item) = {dt1, dt2, dt3, ...}
  Display all items planned to be accessed within the enquiry date+time set:
    display( {item | item ε item.planned.all_{∪} , datetime.planned(item) ε enquiry} )
```

As previously mentioned, the first embodiment relates to a travel planning domain implementation of the best mode. This will now be described using the following tables to align with the pseudo code description using the references provided in each of the modules.

In the research analysis module 50, an example of the results generated by the process 1 (a)(i) defining different categories is as follows:

Category
Golf
Fishing
Markets

An example of measures, groups and values applied to such as generated by process 1(a)(ii) and performed based on those results at 1(b)(i) and 1(b)(ii) is as follows:

| Measure | Group | Value |
|---|---|---|
| >2 | H | 9 |
| >1, <=2 | M | 3 |
| >0, <=1 | L | 1 |
| 0 | 0 | 0 |

Measures may be counts, quality, diversity, etc

An example of the persona declared interest generated by process 1(a)(iii) is as follows:

Persona Declared interest

| Category | Group | Value |
|---|---|---|
| Golf | H | 9 |
| Fishing | M | 3 |
| Markets | L | 1 |

An example of the tabulating and recording at step 1(b)(iii) is as follows:

Location 1

| Category | Measure | Group | Value |
|---|---|---|---|
| Golf | 2 | M | 3 |
| Fishing | 3 | H | 9 |
| Markets | 1 | L | 1 |

Location 2

| Category | Measure | Group | Value |
|---|---|---|---|
| Golf | 3 | H | 9 |
| Fishing | 2 | M | 3 |
| Markets | 2 | M | 3 |

Location 3

| Category | Measure | Group | Value |
|---|---|---|---|
| Golf | 1 | L | 1 |
| Fishing | 1 | L | 1 |
| Markets | 0 | 0 | 0 |

An example of the recorded evaluation of items generated by process 1(a)(v) and the step of adjusting the numerical values as performed at 1(b)(iv) is as follows:

Location 3 Evaluation

| Category | Eval | Value |
|---|---|---|
| Golf | H | 9 |
| Fishing | M | 3 |
| Markets | M | 3 |

Location 3 Revised Category Values

| Category | Value | Eval | Revised |
|---|---|---|---|
| Golf | 1 | 9 | (1 + 9)/2 = 5 |
| Fishing | 1 | 3 | (1 + 3)/2 = 2 |
| Markets | 0 | 3 | (0 + 3)/2 = 1.5 |

50% weighted average used for this example

An example of the calculating and recording performed by step 1(b)(v) is as follows:

If Location 1 were accessed the revised Interests are:

Persona Revised Interest

| Category | Declared | Observed | Revised |
|---|---|---|---|
| Golf | 9 | 3 | (9 + 3)/2 = 6 |
| Fishing | 3 | 9 | (3 + 9)/2 = 6 |
| Markets | 1 | 1 | (1 + 1)/2 = 1 |

50% weighted average used for this example

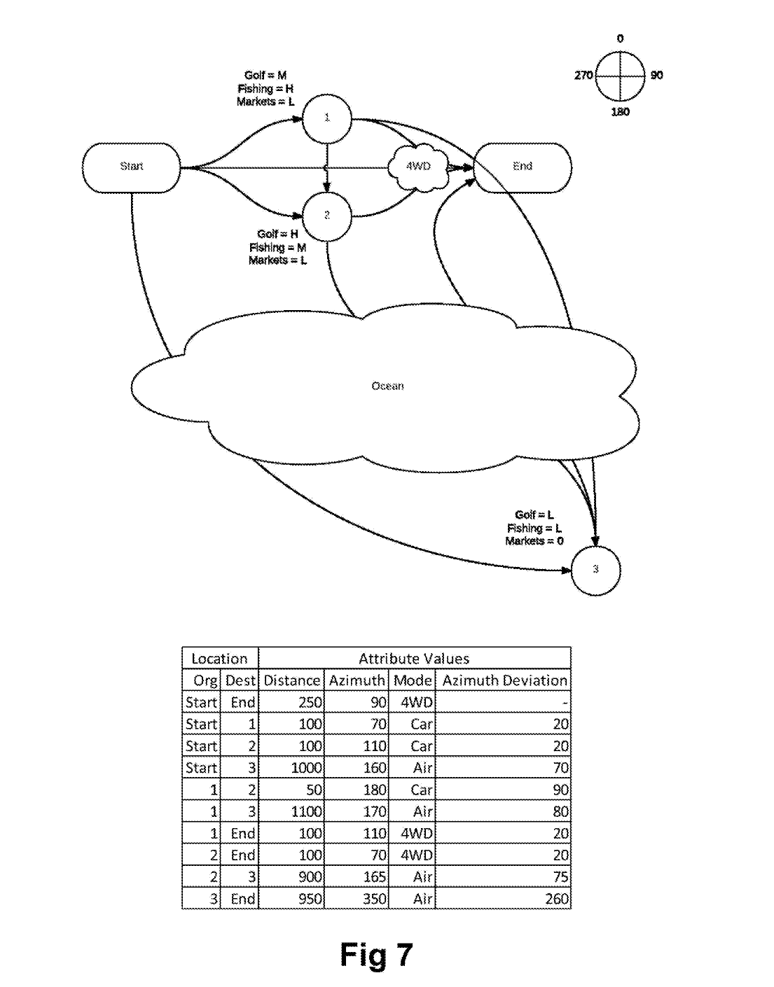

In the analyse module 54, reference is made to the diagrammatic flow chart at FIG. 7 showing an example of the processes generated and steps performed by the pseudo code with particular item location and attribute value data provided in the table included as part of FIG. 7.

An example of the persona declared preferences generated by the process at 2(a)(ii) in accordance with the data provided at FIG. 7 is as follows:

Persona Declared Preferences

| Distance Maximum | | <=500 |
|---|---|---|
| Azimuth Deviation | | <=30 |
| Car | H | 9 |
| 4WD | M | 3 |
| Air | L | 1 |

An example of calculating and recording the observed preferences as performed by step 2(b)(1) if location 2 as shown in FIG. 7 were accessed, is as follows:

If Location 2 were accessed the observed preferences are:

| | | | | | Observed | | |
|---|---|---|---|---|---|---|---|
| Location | | Attribute Values | | | Azimuth | | |
| Org | Dest | Distance | Azimuth | Mode | Deviation | Distance | Mode |
| Start | End | 250 | 90 | 4WD | — | — | — |
| Start | 2 | 100 | 110 | Car | 20 | 100 | Car |
| 2 | End | 100 | 70 | 4WD | 20 | 100 | 4WD |

ave=20 sum=200

An example of calculating and recording the revised preferences as performed by step 2(b)(i) if location 2 as shown in FIG. 7 were accessed, is as follows:

If Location 2 were accessed the revised preferences are

Persona Revised Preferences

| Declared | | | Observed | Revised |
|---|---|---|---|---|
| Distance Maximum | | <=500 | 200 | (500 + 200)/2 = 350 |
| Azimuth Deviation | | <=30 | 20 | (30 + 20)/2 = 25 |
| Car | H | 9 | Y = 9 | (9 + 9)/2 = 9 |
| 4WD | M | 3 | Y = 9 | (3 + 9)/2 = 6 |
| Air | L | 1 | N = 0 | (1 + 0) = 0.5 |

50% weighted average used for this examole

In the suggestion module 58, an example of the recording of persona planned access performed at step 3(b)(i) is as follows:

Planned Set

| Location | | Attribute Values | | | |
|---|---|---|---|---|---|
| Org | Dest | Distance | Azimuth | Mode | Azimuth Deviation |
| Start | End | 250 | 90 | 4WD | — |

An example of the electing of the candidate set performed at step 3(b)(ii) is as follows:

Candidate Set

| Category | Location 1 | Location 2 | Location 3 |
|---|---|---|---|
| Golf | 6 × 3 = 18 | 6 × 9 = 54 | 6 × 5 = 30 |
| Fishing | 6 × 9 = 54 | 6 × 3 = 18 | 5 × 2 = 12 |
| Markets | 1 × 1 = 1 | 1 × 3 = 3 | 1 × 1.5 = 1.5 |

An example of the reducing of the candidate set performed at step 3(b)(iii) is as follows:

Candidate Set

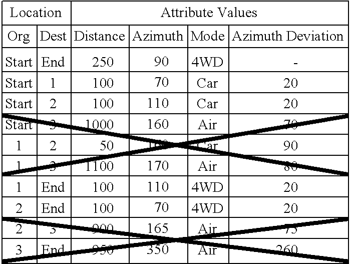

An example of the calculating of the relative interest performed at step 3(b)(iv) is as follows:

Candidate Set

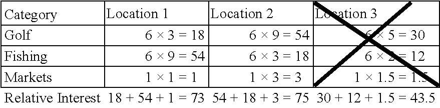

An example of the selecting from the candidate step performed at step 3(b)(v) is as follows:

Candidate Set

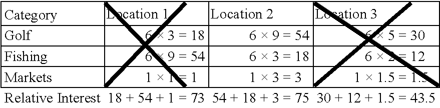

It should be appreciated that the scope of the present invention is not limited to the best mode, or the specific embodiments described. Other modes and embodiments may be envisaged that use different combinations of aspects of the best mode without departing from the spirit of the invention and are deemed to fall within its scope.

In this respect, it should be appreciated that the embodiment of the invention in determining the interests and suggestions of a persona, may include applications such as follows:
creating search engine suggestions (le: different from results)
creating suggestions from analysis of shopping generally
creating suggestions from analysis of savings/credit/loyalty card usage
creating suggestions from analysis of installed/portable GPS car/cycle/pedestrian/transport usage
creating suggestions from analysis of library/collection loan/retrieval usage (eg: book, video, audio, game)
creating suggestions from analysis of media usage (eg:

broadcast/cable/satellite video/audio, Internet TV/video/audio/gamelbook/web site)
creating suggestions from analysis of machine to machine communication.

Also the technical implementation of the embodiment of the invention is not limited to that described in the preceding embodiments. For example usage of the invention may be via the public Internet and an open group of personas. It may also be a private network shared amongst a closed group of one or more personas (i.e.: private Internet/Intranet/“Cloud”), or it may be totally disconnected usage on a device (which may or may not have intermittent network connection) by a group of one or more personas.

Furthermore, whilst the specific embodiments have described the function that is applied in calculating the relative interest in terms of a multiplier of the recorded interest of the persona for each category/item combination and the recorded numerical values of each category/item combination, and other like calculations, the invention is not limited to such. In other embodiments, other functions may be applied, such as sum of differences, least squares and best fit calculations, etc.

It is also important to note that machine to machine (also known as the Internet of Things) communication results from devices sharing information with or without a direct instruction to do so from a user. In this context, the present invention may be embodied so that the persona may be the device itself and not the user of the device. An example is a mobile phone communicating to a mobile phone tower—based upon observed interests and preferences of the user the device may make a more informed automatic choice of provider—say to one that has streaming music at no cost of the categories the user likes. Another example may be building automation system communicating to security/air-conditioning/entertainment/maintenance systems that observes occupant usage of rooms/power/water/light/heating/cooling/media, scheduling robotic cleaning and commanding adjustment of lighting/temperature/media in a variety of rooms in anticipation of or as a result of usage.

1. A method for analysing in a prescribed domain interests of a persona who interacts with a repository of information containing: items that may embody one or more interests of a persona in that domain, categories that are a collection of all possible interests of a persona relative to that domain, and values that constitute a measure of the quality or quantity prescribed for each interest; the method including:
creating a category/item database comprising: items, categories of interests for each item and values of those interests prescribed for each item; and
generating a persona interest database from the category/item database for providing items with categories of interest for a persona having regard to one or any combination of a persona's:
(1) evaluation of the categories of particular items designated by the persona;
(2) accessing of a particular item or a category of a particular item accessed by the persona;
(3) declared interests.

2. A method as claimed in claim 1, wherein the category/item database is created by:
(i) determining a set of discrete categories of interests for each item based upon the inherent characteristics of each item;
(ii) calculating a value for each category of interest for each item, the value being a relative rating based upon a generic assessment of the measure of that interest as it applies to the particular item to which the interest is being prescribed; and
(iii) generating a category profile for each item based on the determined categories of interest and the value calculated for each category of interest applicable to the item.

3. A method as claimed in claim 1, wherein regard of the evaluation of the categories of a particular item by the persona includes receiving evaluation data from the persona, rated according to the same measurement criteria applied to the particular category of interest used for calculating a value for the category of interest of the particular item in the category/item database, and combining the rated evaluation data with the value of that interest applied to the particular item as derived from the category/item database in accordance with a prescribed evaluation function.

4. A method as claimed in claim 1, wherein regard of the accessing of an item by the persona includes receiving actual access data from the persona or sources independent of the persona pursuant to the persona accessing the particular item and calculating a list of observed interests of the persona based on the category profile of the item derived from the category/item database according to the actual access data.

5. A method as claimed in claim 1, wherein regard of the declared interests of the persona includes receiving declared interest data from the persona for categories of interest nominated by the persona, rated according to the same measurement criteria applied to the particular categories of interest in the category/item database, and combining the rated declared interest data with the value of those interests derived from the category/item database for all of those items evaluated or accessed by the persona, in accordance with a prescribed declaration of interest function.

6. A method for analysing in a prescribed domain the interests of a persona interacting with a repository containing information that may serve those interests, including:
(a) generating results from the following process steps:
(i) defining a persona who is an individual that a user may become or is a user, or a group of individuals who share a common behaviour or intent;
(ii) defining an item which is an embodiment of an interest to a persona;
(iii) defining categories that are collections of interests of persona;
(iv) defining measures which are numerical values representative of the relative interest of a persona for a category;
(v) for each persona, recording one or more declared interests as numerical values representing relative rankings as declared by each persona;
(vi) for each persona, recording actual or planned access to items;
(vii) recording persona evaluations of items;
(b) performing the following steps based on those results:
(i) defining groups each containing a range of measures;
(ii) allocating numerical values to each group in proportion to the measure or range of measures contained in that group;
(iii) tabulating and recording for each category/item combination the numerical value allocated to the group containing the measure of that category/item combination;
(iv) for each tabulated category/item, adjusting numerical values as a combination of the calculated group values at step (b)(iii) and persona evaluations at step (a)(vii);
(v) for each persona calculating and recording as interests for each category the combination of declared interests at step (a)(v) and category/item numerical values at step (b)(iv) of items accessed.

7. A method for analysing in a prescribed domain preferences of a persona who interacts with a repository containing: items that may embody one or more interests of a persona in that domain, relationships between the items, and attribute values that constitute a measure of the quality or quantity prescribed for each relationship; the method including:
creating an item relationship database including: items where an item may also include a set of items, attributes indicative of relationships between items and attribute values of those relationships prescribed for each linking of items; and
generating a persona preference database from the item relationship database for providing preferences of items for a persona having regard to either or both of a persona's:
(1) accessing of sets of items; (2) declared preferences.

8. A method as claimed in claim 7, wherein the item relationship database is created by:
(i) determining a generic set of discrete relationship attributes between each linking of items based upon the inherent characteristics of each item;
(ii) calculating an attribute value for each attribute relationship between each linking of items, the attribute value being a relative measure of the particular attribute relationship between each linking of items;
(iii) generating an attribute relationship profile for each linking of items based on the determined attributes for the linking of items and the attribute value calculated for each attribute relationship applicable to the linked items.

9. A method as claimed in claim 7, wherein regard of the accessing of sets of items by the persona includes receiving actual access data from the persona or sources independent of the persona pursuant to the persona accessing a particular set of items and calculating a list of observed preferences of the persona based on the attribute relationship profile of each linked item within the particular set of items, the attribute relationship profile being derived from the item relationship database according to the actual access data.

10. A method as claimed in claim 7, wherein regard of the declared preferences of the persona includes receiving declared preference data from
the persona for relationship attributes nominated by the persona, rated according to the same measurement criteria applied to the particular attribute relationship in the item relationship database, and combining the rated declared interest data with the value of those attribute relationships derived from the item relationship database for all of those items accessed by the persona, in accordance with a prescribed declaration of preference function.

11. A method for analysing the preferences of a persona interacting with a repository containing information that may serve those interests, including:
(a) generating results from the following process steps:
defining attributes that are numerical values measuring relationships between items;
(ii) for each persona, recording one or more declared preferences as numerical values measuring item attributes;
(iii) for each persona, recording access to items into one or more sets and where appropriate the ordering of those items in a set;
(b) performing the following steps based on those results:
(i) for each persona, calculating and recording as preferences for each attribute the combination of the declared preferences as generated at step (a)(ii) and calculated attribute values of item relationships in sets accessed.

12. A method for suggesting items in a prescribed domain that are aligned with the predetermined interests and preferences of a persona stored in a repository of information in response to an item plan access of a persona interacting with the repository, the repository including: items that may embody one or more interests of a persona in that domain, categories that are a collection of all possible interests of a persona relative to that domain, values that constitute a measure of the quality or quantity prescribed for each interest, relationships between the items, and attribute values that constitute a measure of the quality or quantity prescribed for each relationship; the method including:
calculating a set of preferred items for the persona based on previous analysis of the preferences of the persona as stored in the repository that are not in a planned set of items of the persona; and
selecting items with the highest relative interest from the set of preferred items as item suggestions.

13. A method as claimed in claim 12, wherein calculating the set of preferred items includes:
(i) receiving item plan access data comprising a set of items planned for a persona;
(ii) selecting a candidate set of items calculated to not be in the planned set of items; and
(iii) reducing the candidate set to those items that have attribute values within a threshold relative to the predetermined preferences of the persona for each relationship between the items.

14. A method as claimed in claim 12, wherein selecting the candidate set as suggestions includes:
(i) calculating the relative interest of the persona for each item in the candidate set as a function of a recorded interest of the persona for each category/item combination and recorded values of the category interest for each category/item combination; and
(ii) selecting from the candidate set as suggestions those items with the highest values of relative interest.

15. A method as claimed in claim 14, wherein the recorded interest of the persona is derived from a persona interest database generated according to claim 1.

16. A method as claimed in claim 13, wherein the predetermined preferences of the persona are derived from a persona preference database generated according to the method of claim 7.

17. A method as claimed in claim 12, wherein the function of a recorded interest of the persona and the recorded values of each category/item combination comprises the sum of multiplying the recorded interest of the persona for each category/item combination by the recorded numerical values of each category/item combination.

18. A method for suggesting items aligned with the interests, preferences and planned item access of a user interacting with a database containing information that may serve those interests, including:
(a) generating results from the following process steps:
(i) analysing the interests of personas using the method as claimed in claim 6;
(ii) analysing the preferences of personas using the method as claimed in claim 11;
(b) performing the following steps based on those results:
(i) for each persona, recording persona planned access to items and the ordering of items in one or more sets;
(ii) for each persona, selecting a candidate set of items not in the planned set;
(iii) reducing the candidate set to those items that have attributes within a threshold relative to the preferences of a persona (ref claim 10(b)(ii)) for each attribute;
(iv) calculating the relative interest of the persona for each item in the candidate set as the sum of multiplying the recorded interest of the persona for each category/item combination (ref claim 6(b)(v)) by the recorded numerical values of each category/item combination (ref claim 6(b)(iv));
(v) selecting from the candidate set those items with the highest values of relative interest as derived from step (b)(iv)).

19. A method for suggesting items in a prescribed domain that are aligned with the interests and preferences of a user based on the interests and preferences of persona stored in a repository of information in response to an item plan access of the user interacting with the repository, the repository including: items that may embody one or more interests of a persona in that domain, categories that are a collection of all possible interests of a persona relative to that domain, values that constitute a measure of the quality or quantity prescribed for each interest, relationships between the items, and attribute values that constitute a measure of the quality or quantity prescribed for each relationship; the method including:
receiving item plan access data comprising a set of items planned for a user;
selecting a candidate set of items not in the planned set of items;
reducing the candidate set to those items that have attribute values within a threshold relative to preferences of a user derived from the item plan access data for each relationship between the items;
calculating the relative interest of the user for each item in the candidate set as a function of the interest of the user derived from the item plan access data for each category/item combination and recorded values of each category/item combination; and
selecting from the candidate set as suggestions those items with the highest values of relative interest.

20. A method for sharing user plans, activity and experiences with communities of users interacting with a database containing information that may serve those interests, including:
(a) generating results from the following process steps:
(i) recording planned item access and suggested items derived from the methods as claimed in claim 13;
(ii) defining communities of personas sharing common interests and/or preferences;
(iii) recording persona memberships of communities; (iv) recording persona evaluations of items;
(v) recording persona comments about items; (vi) recording descriptions of items;
(vii) recording the current location of a persona; (viii) recording the current date and time;
(ix) recording trusted persona evaluations of items; (b) performing the following steps based on those results:
(i) displaying items planned to be accessed for the user making an enquiry;
(ii) displaying suggested items for the user making the enquiry (refer claim 13 (b)(v));
(iii) optionally displaying item sets where date and time items are accessible fall within the date and time range chosen by a user making an enquiry;
(iv) optionally displaying item sets from personas where personas are members of a common community with a user making an enquiry;
(v) optionally displaying item sets from personas where those personas have actual/planned access within the date and time range chosen by a user making an enquiry;
(vi) optionally displaying item sets from trusted personas;
(vii) optionally displaying lines which may indicate the order direction connecting items in a set in their chosen order;
(viii) optionally displaying items being accessed by other personas at the current date and time;
(ix) optionally displaying one or more item descriptions, comments and evaluations;
(x) optionally display items distinctively for one or more of:
item set, item category, item attribute, item date and time accessible, item evaluation, item access count, persona community membership, trusted persona.

21. A system for analysing in a prescribed domain interests of a persona who interacts with a repository of information containing: items that may embody one or more interests of a persona in that domain, categories that are a collection of all possible interests of a persona relative to that domain, and values that constitute a measure of the quality or quantity prescribed for each interest; the system including:
a category/item database comprising: items, categories of interests for each item and values of those interests prescribed for each item;
a calculate category/item values process to create and calculate category/item values for each item stored in the repository; and
a persona interest database for providing items with categories of interest for a persona having regard to one or any combination of a persona's:
(1) evaluation of the categories of particular items designated by the persona;
(2) accessing of a particular item or a category of a particular item accessed by the persona;
(3) declared interests.

22. A system as claimed in claim 21, wherein the calculate category/item values process includes a categories process for determining a set of discrete categories of interests for each item based upon the inherent characteristics of each item.

23. A system as claimed in claim 21, wherein the calculate category/item values process includes a value process for calculating a value for each
category of interest for each item, the value being a relative rating based upon a generic assessment of the measure of that interest as it applies to the particular item to which the interest is being prescribed.

24. A system as claimed in claim 21, wherein the calculate category/item values process includes a profiling process for generating a category profile for each item based on the determined categories of interest and the value calculated for each category of interest applicable to the item.

25. A system as claimed in claim 21, including an evaluation process for performing the evaluation of the categories of the particular items by the persona, the evaluation process being programmed to:
(a) receive evaluation data derived from the persona, rated according to the same measurement criteria applied to the particular category of interest used for calculating a value for the category of interest of the particular item in the category/item database; and
(b) combine the rated evaluation data with the value of that interest applied to the particular item as derived from the category/item database in accordance with a prescribed evaluation function.

26. A system as claimed in claim 21, including:
(a) an accessing process for accessing a particular item or a category of a particular item by the persona, the accessing process being programmed to receive actual access data from the persona or sources independent of the persona pursuant to the persona accessing the particular item; and
(b) a calculate persona observed interests process to calculate a list of observed interests of the persona based on the category profile of the item derived from the category/item database according to the actual access data.

27. A system as claimed in claim 21, including a persona declared interests process programmed to:
(a) receive declared interest data from the persona for categories of interest nominated by the persona, rated according to the same measurement
criteria applied to the particular categories of interest in the category/item database; and
(b) combine the rated declared interest data with the value of those interests derived from the category/item database for all of those items evaluated or accessed by the persona, in accordance with a prescribed declaration of interest function.

28. A system for analysing in a prescribed domain preferences of a persona who interacts with a repository containing: items that may embody one or more interests of a persona in that domain, relationships between the items, and attribute values that constitute a measure of the quality or quantity prescribed for each relationship; the system including:
an item relationship database including: items where an item may also include a set of items, attributes indicative of relationships between items and attribute values of those relationships prescribed for each linking of items;
a calculate item relationship attributes process to calculate attribute values of item relationships to create the item relationship database; and
a persona preference database for providing preferences of items for a persona having regard to either or both of a persona's:
(1) accessing of sets of items; (2) declared preferences.

29. A system as claimed in claim 28, wherein the calculate item relationship attributes process includes an attributes process for determining a generic set of discrete relationship attributes between each linking of items based upon the inherent characteristics of each item.

30. A system as claimed in claim 28, wherein the calculate item relationship attributes process includes an attribute value process for calculating an attribute value for each attribute relationship between each linking of items, the attribute value being a relative measure of the particular attribute relationship between each linking of items.

31. A system as claimed in claim 28, wherein the calculate item relationship attributes process includes an attribute relationship process for generating an attribute relationship profile for each linking of items based on the determined attributes for the linking of items and the attribute value calculated for each attribute relationship applicable to the linked items.

32. A system as claimed in claim 28, including:
(a) an actual set access process for accessing sets of items, the actual set access process being programmed to receive actual access data from the persona or sources independent of the persona pursuant to the persona accessing a particular set of items; and
(b) a calculate persona observed preferences process to calculate a list of observed preferences of the persona based on the attribute relationship profile of each linked item within the particular set of items, the attribute relationship profile being derived from the item relationship database according to the actual access data.

33. A system as claimed in claim 28, including a declared preference process programmed to:
(a) receive declared preference data from the persona for relationship attributes nominated by the persona, rated according to the same measurement criteria applied to the particular attribute relationship in the item relationship database; and
(b) to combine the rated declared interest data with the value of those attribute relationships derived from the item relationship database for all of those items accessed by the persona, in accordance with a prescribed declaration of preference function.

34. A system for suggesting items in a prescribed domain that are aligned with the predetermined interests and preferences of a persona stored in a repository of information in response to an item plan access of a persona interacting with the repository, the repository including: items that may embody one or more interests of a persona in that domain, categories that are a collection of all
possible interests of a persona relative to that domain, values that constitute a measure of the quality or quantity prescribed for each interest, relationships between the items, and attribute values that constitute a measure of the quality or quantity prescribed for each relationship; the system including:
a ‘calculate candidate set using preferences’ process to calculate a set of preferred items for the persona based on previous analysis of the preferences of the persona as stored in the repository that are not in a planned set of items of the persona; and
a ‘calculate candidate set using interests’ process to select items with the highest relative interest from the set of preferred items as item suggestions.

35. A system as claimed in claim 34, wherein the calculate candidate set using preferences process includes:
(a) an item plan process for receiving item plan access data comprising a set of items planned for a persona;
(b) a candidate item process for selecting a candidate set of items calculated to not be in the planned set of items; and
(c) a reduction process for reducing the candidate set to those items that have attribute values within a threshold relative to the predetermined preferences of the persona for each relationship between the items.

36. A system as claimed in claim 35, wherein the predetermined preferences of the persona are derived from a persona preference database generated according to the system of claim 28.

37. A system as claimed in claim 34, wherein the calculate candidate set using interests process includes:
(a) a calculation process for calculating the relative interest of the persona for each item in the candidate set as a function of a recorded interest of the persona for each category/item combination and recorded values of the category interest for each category/item combination; and
(b) a selection process for selecting from the candidate set as suggestions of those items with the highest values of relative interest.

38. A system as claimed in claim 37, wherein the recorded interest of the persona is derived from a persona interest database generated according to the system of claim 21.

39. A system as claimed in claim 37, wherein the function of a recorded interest of the persona and the recorded values of each category/item combination comprises the sum of multiplying the recorded interest of the persona for each category/item combination by the recorded numerical values of each category/item combination.

40. A method for suggesting items in a prescribed domain that are aligned with the interests and preferences of a user based on the interests and preferences of persona stored in a repository of information in response to an item plan access of the user interacting with the repository, the repository including: items that may embody one or more interests of a persona in that domain, categories that are a collection of all possible interests of a persona relative to that domain, values that constitute a measure of the quality or quantity prescribed for each interest, relationships between the items, and attribute values that constitute a measure of the quality or quantity prescribed for each relationship; the method including:
calculating a set of preferred items for the user based on previous analysis of the preferences of the persona as stored in the repository that are not in a planned set of items of the persona; and
selecting items with the highest relative interest from the set of preferred items as item suggestions.

41. A method as claimed in claim 40, wherein calculating the set of preferred items includes:
(i) receiving item plan access data comprising a set of items planned for the user;
(ii) selecting a candidate set of items calculated to not be in the planned set of items; and)
(iii) reducing the candidate set to those items that have attribute values within a threshold relative to the predetermined preferences of the user for each relationship between the items.

42. A method as claimed in claim 40, wherein selecting the candidate set as suggestions includes:
(i) calculating the relative interest of the user for each item in the candidate set as a function of a recorded interest of the user for each category/item combination and recorded values of the category interest for each category/item combination; and
(ii) selecting from the candidate set as suggestions those items with the highest values of relative interest.

43. A method for sharing user plans, activity and experiences with communities of users interacting with a database containing information that may serve those interests, including:
(a) generating results from the following process steps:
(i) recording planned item access and suggested items derived from the methods as defined in the further aspect of the invention;
(ii) defining communities of personas sharing common interests and/or preferences;
(iii) recording persona memberships of communities; (iv) recording persona evaluations of items;
(v) recording persona comments about items; (vi) recording descriptions of items;
(vii) recording the current location of a persona; (viii) recording the current date and time;
(b) performing the following steps based on those results:
(i) displaying items planned to be accessed for the user making an enquiry;
(ii) displaying suggested items for the user making the enquiry;
(iii) optionally displaying item sets where date and time items are accessible fall within the date and time range chosen by a user making an enquiry;
(iv) optionally displaying item sets from personas where personas are members of a common community with a user making an enquiry;
(v) optionally displaying item sets from personas where those personas have actual/planned access within the date and time range chosen by a user making an enquiry;
(vi) optionally displaying lines which may indicate the order direction connecting items in a set in their chosen order;
(vii) optionally displaying items being accessed by other personas at the current date and time;
(viii) optionally displaying one or more item descriptions, comments and evaluations;
(ix) optionally display items distinctively for one or more of:
(x) item set, item category, item attribute, item date and time accessible, item evaluation, item access count, persona community membership.

44. A system for suggesting items in a prescribed domain that are aligned with the predetermined interests and preferences of a user based on the interests and preferences of persona stored in a repository of information in response to an item plan access of a persona interacting with the repository, the repository including: items that may embody one or more interests of a persona in that domain, categories that are a collection of all possible interests of a persona relative to that domain, values that constitute a measure of the quality or quantity prescribed for each interest, relationships between the items, and attribute
values that constitute a measure of the quality or quantity prescribed for each relationship; the system including:
a ‘calculate candidate set using preferences’ process to calculate a set of preferred items for the persona based on previous analysis of the preferences of the persona as stored in the repository that are not in a planned set of items of the persona; and
a ‘calculate candidate set using interests’ process to select items with the highest relative interest from the set of preferred items as item suggestions.
